(19) United States
(12) Patent Application Publication
(10) Pub. No.: US 2014/0229540 A1
(43) Pub. Date: Aug. 14, 2014

(54) Handicapping Services

(71) Applicant: Paul Lavers, Halifax (CA)

(72) Inventor: Paul Lavers, Halifax (CA)

(21) Appl. No.: 13/767,427

(22) Filed: Feb. 14, 2013

(51) Int. Cl. H04L 12/58

(52) U.S. Cl. CPC H04L 51/32
USPC 709/204

(57) ABSTRACT

The instant application discloses, among other things, techniques to allow analysis, predictions, or other observations made by a professional, for example a sports handicapper, a weather forecaster, or a stock analyst, to be obtained by subscribers through various communication options.

### FIELD

This disclosure relates to Handicapping Services.

### BACKGROUND

Professional sports handicappers monitor and collect information to predict outcomes on particular aspects of sporting events. Subscribers to the resulting plays often receive updates when they seek them rather than receiving notifications about changes in circumstances which change the predictions.

Handicappers sometimes use existing technologies such as websites, emails, and instant messages, but on an ad hoc basis.

### SUMMARY

The instant application discloses, among other things, techniques to provide handicappers a simplified interface to distribute items, which may include predictions and other information in more reliable, consistent, and faster ways. Handicappers may provide predictions (or “picks”) for sporting events, share prices in a stock market, weather, or any other topic. Items may include picks, news, observations, or other insights to subscribers, with updates distributed regularly, for example on an hourly basis, or on an irregular timetable, for example news as it happens. One skilled in the art will recognize than many different events may trigger distribution of items.

A subscriber may be a person (“user”) or a device capable of receiving notifications, predictions or other types of information from one or more handicappers, via a way supported by Handicapping Services.

A combination of hardware and software may be used to allow a subscriber to select which items the subscriber will receive, as well as how the information will be delivered. For example, a user may choose to receive predictions about professional football games on a particular day, and that the user wishes to receive the information via instant messages. Another user may wish the same information delivered via a microblog site such as TWITTER™ or email. Many different types of items and methods of delivery may be integrated into the hardware and software.

### BRIEF DESCRIPTION OF THE DRAWINGS

FIG. 1 is an example of a system on which Handicapping Services may be implemented according to one embodiment.

FIG. 2 is a block diagram of creating predictions for Handicapping Services according to one embodiment.

FIG. 3 is a block diagram illustrating input to a Handicapping Services server according to one embodiment.

FIG. 4 is a block diagram illustrating output from a Handicapping Services server according to one embodiment.

FIG. 5 is a flow chart for one embodiment of Handicapping Services.

FIG. 6 is a flow chart for another embodiment of Handicapping Services.

FIG. 7 illustrates a component diagram of a computing device according to one embodiment.

### DETAILED DESCRIPTION

A more particular description of certain embodiments of Handicapping Services may be had by references to the embodiments shown in the drawings that form a part of this specification, in which like numerals represent like objects.

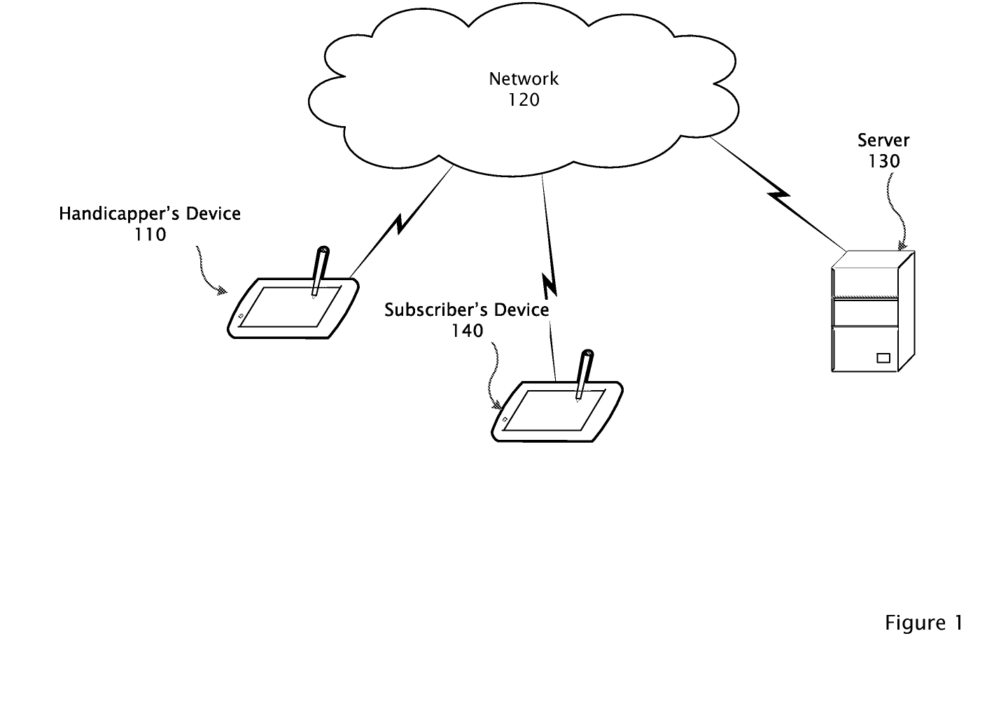

FIG. 1 is an example of a system on which Handicapping Services may be implemented. A handicapper may input items on Handicapper's Device 110, and transfer the items to Server 130 by using Network 120. A user may receive items from Server 130 on Subscriber's Device 140 via Network 120.

Network 120 may include Wi-Fi, cellular data access methods, such as 3G or 4GLTE, the Internet, local area networks, wide area networks, or any combination of these or other means of providing data transfer capabilities.

Server 130 may include one or more computers, and may serve a number of roles, including, but not limited to, storing and retrieving: content, configuration information, subscribed user lists, user preferences, and credentials for both users and handicappers.

Subscriber's Device 140 may be a desktop computer, a laptop, a tablet, a smartphone, a cell phone, a specialized device for this application, or any other type of device capable of receiving notifications.

One skilled in the art will recognize that Handicapper's Device 110, Subscriber's Device 140, and Server 130 may be of many different designs and may have different capabilities.

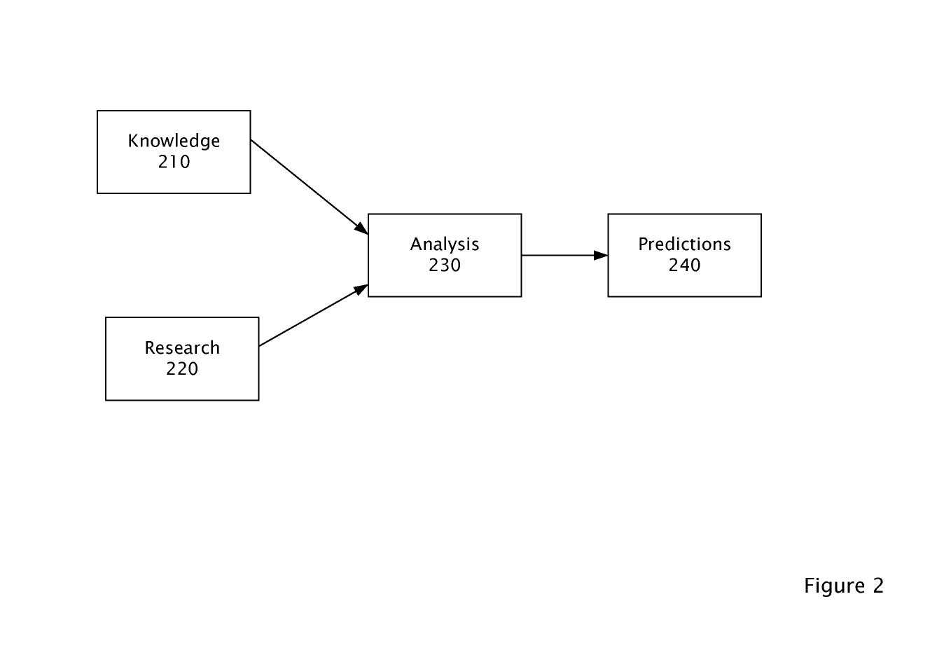

FIG. 2 is a block diagram of creating Predictions 240 for Handicapping Services according to one embodiment. Predictions 240, also known as picks, may be created by a handicapper, and may pertain to any types of information subscribers may wish to have experts or professionals assist in predicting, for example, but not limited to, sports competition outcomes, weather, or stock market prices. Predictions 240 based on Analysis 230 of Knowledge 210 and Research 220. Research 220 may include reading news stories, having discussions with others, watching sports, seeing how players are performing, hearing of industry news, sky-watching, or any other way of obtaining information. One having skill in the art will recognize that research for predicting events may take many different forms depending on a topic, may vary from handicapper to handicapper, and may vary from time to time.

Predictions 240 may change over time as Knowledge 210, Research 220, or Analysis 230 are updated, which may happen multiple times per day. A handicapper may wish to share any of Knowledge 210, Research 220, Analysis 230, or Predictions 240 with subscribers.

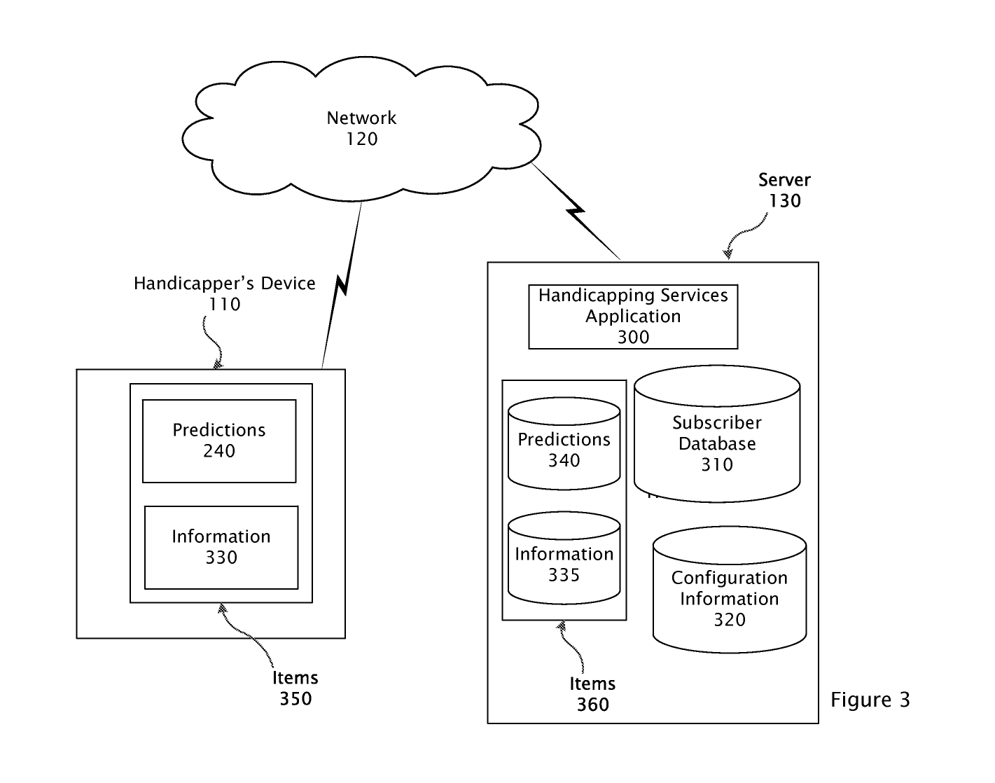

FIG. 3 is a block diagram illustrating input to a Handicapping Services server according to one embodiment. A handicapper may use Handicapper's Device 110 to enter Items 350, which may include Predictions 240 and Information 330 of interest to subscribers. Items 350 may then be transferred via Network 120 to Server 130, where it may be stored as Items 360, and may include Predictions 340 and Information 335.

Handicapping Services Application 300 may be software running on Server 130, or on a combination of servers, networks, and other devices. Handicapping Services Application 300 may be running as one monolithic application, or as components running in a distributed fashion. It may provide various services, including but not limited to, receiving, storing, and distributing Items 360, authenticating subscribers, determining and using communication channels, and distributing notifications. Handicapping Services Application 300 may provide a consistent interface for handicappers to communicate with subscribers.

Server 130 may contain a Subscriber Database 310. Subscribers may be people who receive items from the handicapper. Subscriber Database 310 may include information about subscribers including names, account information, preferences for ways of communicating, billing information, or other information relating to subscribers. One having skill in the art will recognize that Subscriber Database 310 may be made up of one or more physical databases, and that many different storage and file formats may be used. In another embodiment, different information may be stored, or other storage techniques may be implemented.

Configuration Information 320 may include account information for Handicapping Services to distribute Predictions 240. For example, information relating to TWITTER™, email, text messaging, or other forms of communication may be stored, which may allow Server 130 to post or send information so that subscribers may receive it.

Information 335 may include information entered as Information 330 on Handicapper's Device 110, as well as information from other Handicappers or from other sources. This information may be news updates, analyses made by a Handicapper, stock price updates, weather observations, or any other information that may be of interest to subscribers or other handicappers.

Predictions 340 may include a copy of Predictions 240. Predictions 340 may also include additional predictions from other handicappers, and may include various types of predictions depending on a subject matter of the predictions. For example, Predictions 340 may include predictions from several sports handicappers who have predicted outcomes from various sporting events, and from a meteorologist predicting weather. One having skill in the art will recognize that many different storage methods may be used to store and retrieve these types of information.

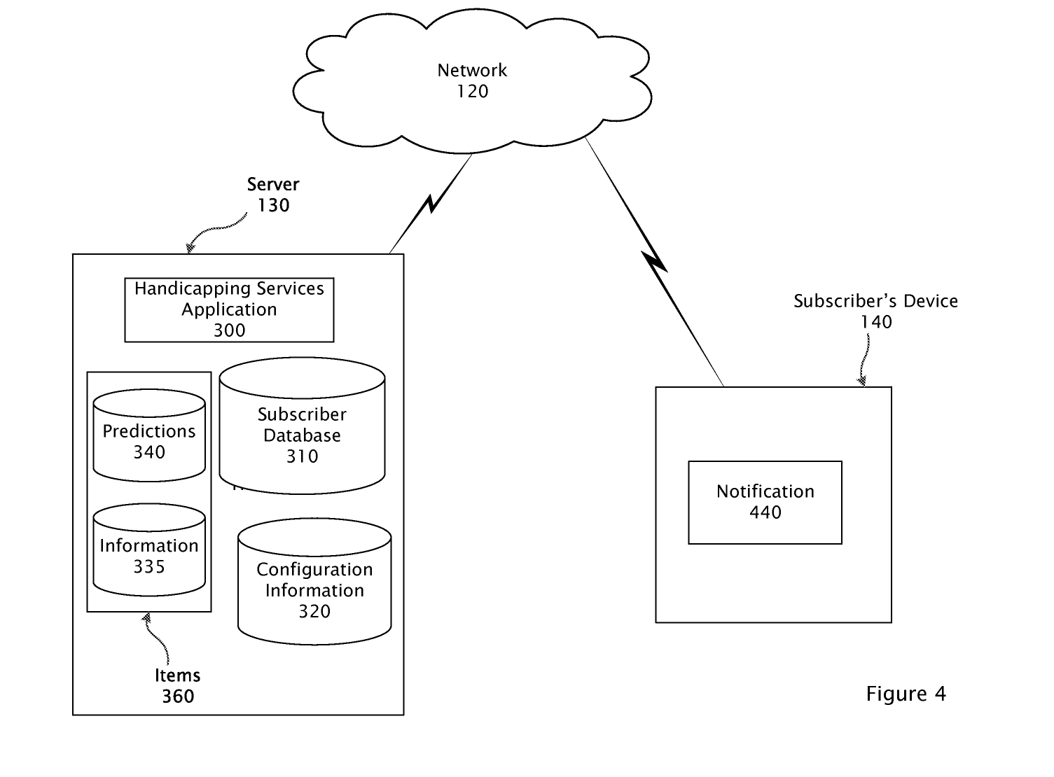

FIG. 4 is a block diagram illustrating output from a Handicapping Services server according to one embodiment. Server 130 may directly or indirectly send one or more notification of Items 360, which may include Predictions 340 or Information 335, to a Subscriber's Device 140 via Network 120. A selection of which notifications to be sent and how they may be sent may be based upon information in Subscriber Database 310, Configuration Information 320, and Items 360. As an example, one subscriber may receive notifications of predictions made by a particular handicapper via an SMS message, while another subscriber may receive notifications of updates of stock prices. Information to allow determining how to send notifications and which subscribers should receive them may be obtained from data contained in one of or a combination of Subscriber Database 310, Configuration Information 320, and Items 360, which may include Predictions 340 and Information 335.

Various communications techniques and applications (“channels”) may be used to transmit notifications to Subscriber's Device 140, including but not limited to TWITTER®, email, SMS, a dedicated software application, a mobile application, a web page, FACEBOOK®, or other social networks. One having skill in the art will recognize that many communication channels and formats may be used, and that a subscriber may use one or more of these options.

Notification 440 may include one or more notifications of Items 360, and may be displayed or stored on Subscriber's Device 140.

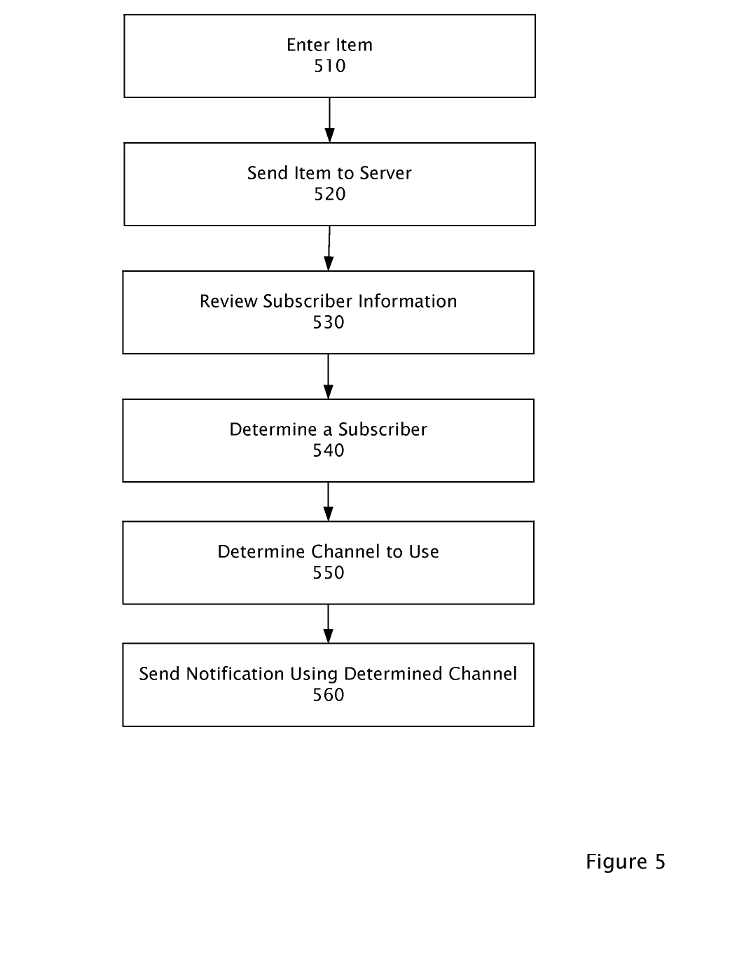

FIG. 5 is a flow chart for one embodiment of Handicapping Services. A handicapper may Enter Item 510 on a Handicapper's Device 110. The Item may be Sent 520 to Handicapping Services, over Network 120. Handicapping Services may perform a process to Review Subscriber Information 530 to Determine a Subscriber 540 to receive a notification of the Item. This may be based upon Subscriber Database 310, Item 360, and Configuration Information 320. Handicapping Services may review Configuration Information 320 and Determine a Channel to Use 550 to deliver a notification. Handicapping Services may then Send Notification Using Determined Channel 560. For example, if the determined subscriber requested delivery of Items via email, Handicapping Services may use an email service to send the notification. In one embodiment, the sent notification may include a link which may allow authentication of a subscriber and allow the subscriber to obtain the prediction or information. In another embodiment, the notification may include the prediction or information.

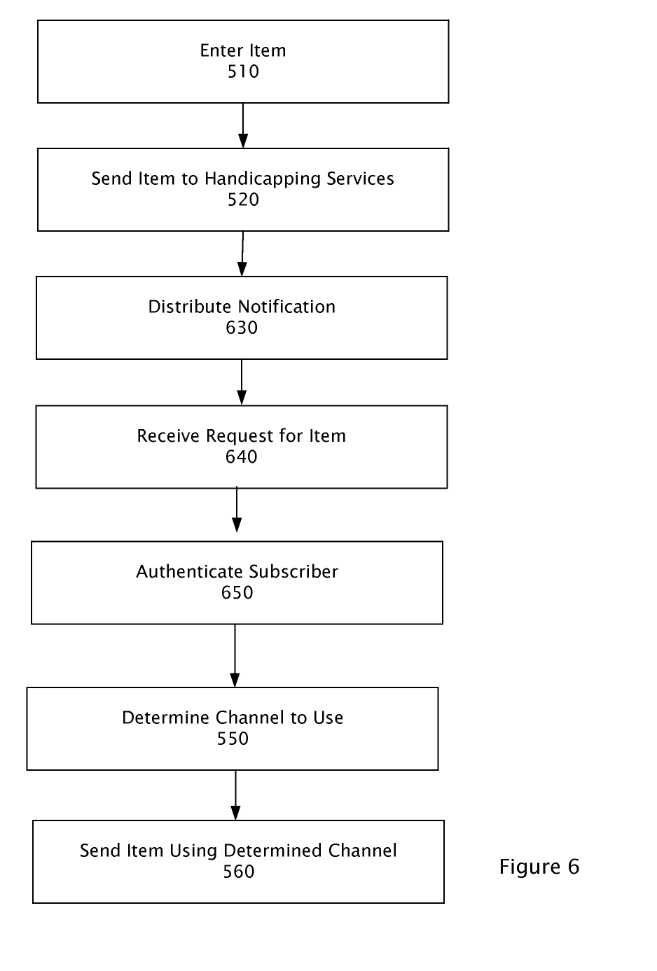

FIG. 6 is a flow chart for another embodiment of Handicapping Services. A handicapper may Enter Item 510 on a Handicapper's Device 110. The Item may be Sent 520 to Handicapping Services, over Network 120. Handicapping Services may Distribute Notification 630 broadly. For example, followers of the Handicapper may receive a notification via TWITTER®, others may receive FACEBOOK® status updates, emails, SMS messages, or any other communication channel to indicate a new item is available. Handicapping Services may then Receive Request for Item 640 from a subscriber, indicating a subscriber wishes to read the item. Handicapping Services may then Authenticate Subscriber 650 and Determine a communications Channel to Use 550 based upon the handicapper, the item, the Subscriber Database 310, and the Configuration Information 320. Handicapping Services may then Send Item Using the Determined Channel 560. For example, if the determined subscriber requested delivery of Items via email, Handicapping Services may use an email service to send the notification. In one embodiment, the sent notification may include a link which may allow authentication of a subscriber and allow the subscriber to obtain the prediction or information. In another embodiment, the notification may include the prediction or information.

One having skill in the art will recognize that there are many possible implementations to provide a similar functionality of Handicapping Services.

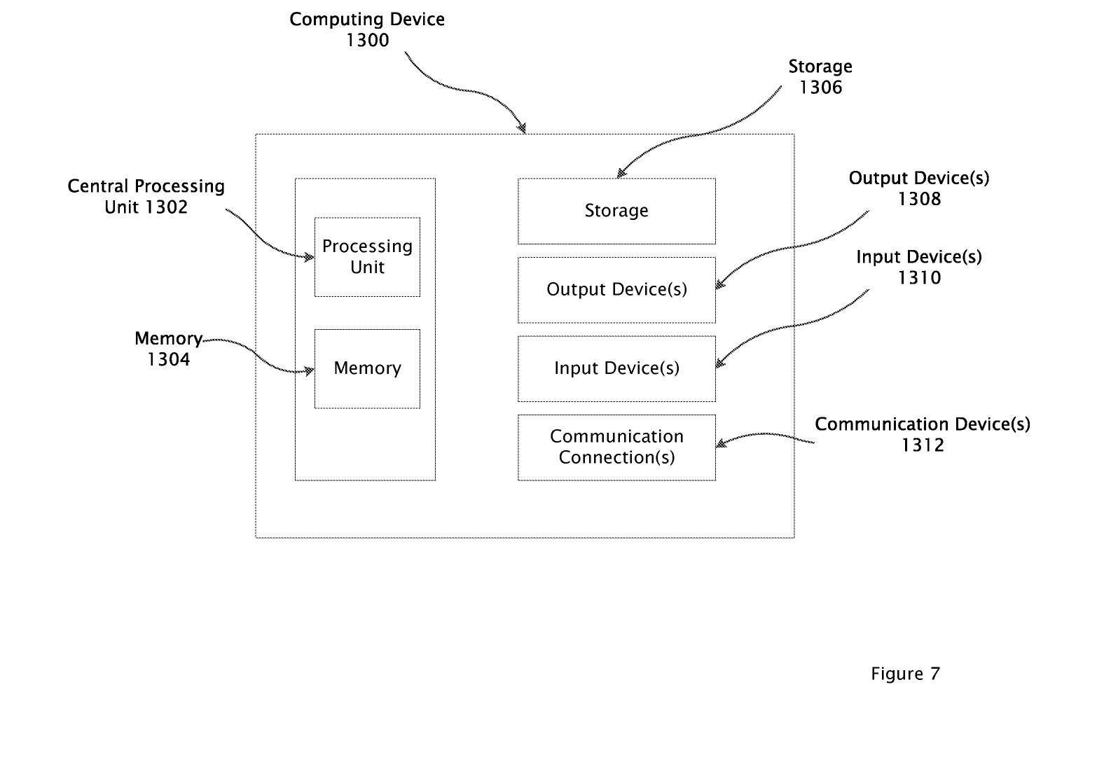

FIG. 7 illustrates a component diagram of a computing device according to one embodiment. The Computing Device (1300) can be utilized to implement one or more computing devices, computer processes, or software modules described herein, including, for example, but not limited to a Handicapper's Device 110, a Subscriber's Device 140, or a Server 130. In one example, the Computing Device (1300) can be utilized to process calculations, execute instructions, receive and transmit digital signals. In another example, the Computing Device (1 300) can be utilized to process calculations, execute instructions, receive and transmit digital signals, receive and transmit search queries, and hypertext, compile computer code as required by a Handicapper's Device 110, a Subscriber's Device 140, or a Server 130. The Computing Device (1 300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1 302) and Memory (1 304). Depending on the exact configuration and type of Computing Device (1 300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media includes volatile and nonvolatile, removable and non-removable media implemented in any method or technology for storage of information such as computer readable instructions, data structures, program modules or other data. Memory (1304) and Storage (1 306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1 300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1 310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A system, comprising:
a processor;
a memory coupled to the processor;
components operable by the processor, comprising:
an item receiving component, configured to receive an item;
a notification distribution component, configured to distribute a notification about the received item;
a request receiving component, configured to receive a request from a subscriber to access the received item.
a subscriber authentication component, configured to authenticate a subscriber based upon the request received;
a subscriber preference component, configured to retrieve subscriber preferences; the subscriber preferences comprising a means of communication for the authenticated subscriber; and
an item distribution component, configured to distribute the received item based upon a means of communication.

2. The system of claim 1, wherein the means of communication is selected from the group consisting of a microblog site, an email, a text message, a dedicated software application, a mobile application, a web page, and a social network.

3. The system of claim 1, wherein the authenticating a subscriber further comprises performing a search on a database.

4. The system of claim 1 wherein the item is a prediction of a result of a sporting event.

5. The system of claim 1 wherein the item is an analysis of a publicly traded company.

6. The system of claim 1 wherein the item is a recommendation concerning shares of a company selected from a group comprising buy, sell, and hold.

7. A computer operable method, comprising:
receiving an item;
determining, based on the item received, a subscriber to receive the item;
determining, based on the determined subscriber, a means of communication; and
sending a notification of availability of the item to the subscriber via the means of communication.

8. The method of claim 7 further comprising posting the item on a web site.

9. The method of claim 7 further comprising:
receiving credentials from the subscriber, the credentials authorizing the subscriber access to the web site; and
displaying the item to the subscriber.

10. A computer storage medium, containing instructions thereon which, when executed by a processor, perform a method comprising:
receiving an item;
sending a notification of an availability of the item;
receiving from a subscriber credentials and a request for the item;
authenticating the subscriber using the received credentials;
determining, based on the subscriber, a means of communication; and
sending the item to the subscriber via the means of communication.

11. The method of claim 10 wherein the means of communication is selected from the group consisting of a microblog site, an email, a text message, a dedicated software application, a mobile application, a web page, and a social network.

12. The method of claim 10 wherein the item is a prediction of a result of a sporting event.

13. The method of claim 10 wherein the item is a news item concerning an upcoming sporting event.

14. The method of claim 10 wherein the item is an opinion about an aspect of an upcoming sporting event.

15. The method of claim 10 wherein the item is a news item concerning weather conditions.
